(19) United States
(12) Patent Application Publication
(10) Pub. No.: US 2007/0277170 A1
(43) Pub. Date: Nov. 29, 2007

(54) MERGER DRIVEN APPLICATION INSTALLATION

(75) Inventors: Rohit V. Kapoor, Brooklin (CA); Glen Shortliffe, Toronto (CA)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/420,375

(22) Filed: May 25, 2006

(51) Int. Cl. G06F 9/445

(52) U.S. Cl. 717/174

(57) ABSTRACT

Embodiments of the present invention address deficiencies of the art in respect to software installation and provide a method, system and computer program product for merger driven software installation. In one embodiment of the invention, an application installation method can be provided. The method can include specifying an installation package for a software product as a source repository and specifying a target repository in a target platform hosted by at least one computing system. Thereafter, a merge operation can be executed with each of the source repository and the target repository so that the target repository is updated according to the source repository.

### BACKGROUND OF THE INVENTION

1. Field of the Invention

The present invention relates to the field of application installation and more particularly to application installers.

2. Description of the Related Art

Though often overlooked, application installation is a prerequisite to interacting with a software application. Specifically, in most circumstances, an application can be properly executed only subsequent to the completion of a successful installation process. At the minimum, a typical software application installation requires a transfer of files to the file structure of a computing system, and the configuration of the computing system to particularly interact with the software application. Ordinarily, the configuration of the computing system includes the addition or modification of registry settings, the addition or modification of entries to one or more initialization files, or both.

Typically, software programs include as a component installer logic having program code enabled to substantially automate the installation process. In addition, computer operating systems occasionally incorporate installer logic for use in installing drivers or other software. Likewise, many commercial software offerings are provided with companion updater logic supporting self-updating operations. Generally, the updater logic can be included as a component of the software program itself, or the updater logic can be provided externally as a third-party tool.

The provision of an updating process is desirable because software programs are frequently modified by end users, for example by applying bug fixes or enhancements (such as new versions of the software). There are many different processes for installing and/or updating software programs. Some processes are entirely automated and substantially invisible to the user, while other processes are better characterized as interactive. Some processes are known to be complex while other processes are viewed to be simpler in nature.

Software programs used to install new software, to install updates to software, and to uninstall (remove) software are referred to herein as “installer applications”. The term “installer applications” is intended to encompass both stand-alone software programs that can be used to install a variety of software applications (for example, such as installers that may be provided with an operating system), as well as software programs that are adapted to install only a single software application (and may be integrated with the installation file package for that software application). Installer applications, when run, implement a software installation process.

The great disparity in the nature of different installer applications provides for challenges in the computing enterprise. Specifically, from the development and deployment perspective, each new application generally requires a custom installer for each target platform. In as much as the installer is customer-facing in nature and represents the first point of contact with a user, the installer is an application component whose role is not to be taken lightly. Thus, substantial development and support resources must be dedicated to the creation and deployment of each custom installer.

### BRIEF SUMMARY OF THE INVENTION

Embodiments of the present invention address deficiencies of the art in respect to software installation and provide a novel and non-obvious method, system and computer program product for merger driven software installation. In one embodiment of the invention, an application installation method can be provided. The method can include specifying an installation package as a source repository and specifying a target repository in a target platform hosted by at least one computing system. Thereafter, a merge operation can be executed with each of the source repository and the target repository so that the target repository is updated according to the source repository.

In one aspect of the embodiment, executing a merge operation with each of the source repository and the target repository can include executing a merge operation with each of an empty target repository and a populated source repository to achieve an installation operation in the target repository. In another aspect, executing a merge operation with each of the source repository and the target repository can include executing a merge operation with each of a populated source repository and a populated target repository to achieve an application update operation in the target repository. In a still further aspect, executing a merge operation with each of the source repository and the target repository can include executing a merge operation with each of an empty source repository and a populated target repository to achieve an uninstallation operation in the target repository.

In another embodiment of the invention, an application installation data processing system can be provided. The data processing system can include a unified installation engine configured for coupling to an abstract file system, and a merge-data operation coupled to the engine. The merge-data operation can include program code enabled to execute a merge operation with each of a source repository and a target repository so that the target repository is updated according to the source repository. Optionally, the abstract file system can include a minimal set of abstract file input/output (I/O) operations translatable to concrete file I/O operations through an adapter specific to the platform hosting the target repository. In this way, an application can be installated and/or updated irrespective of a specific type of platform hosting the target repository

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a data processing system configured for application installation;

FIG. 2 is a flow chart illustrating a process for application installation;

FIG. 3 is a block diagram illustrating a unified form of the installation engine of FIG. 1;

FIG. 4 is a pictorial illustration depicting alternate, uniform operations of the unified installation engine of FIG. 3; and,

FIG. 5 is a block diagram illustrating the polymorphic extension of the unified installation engine of FIG. 3.

### DETAILED DESCRIPTION OF THE INVENTION

Embodiments of the present invention provide a method, system and computer program product for application installation. In accordance with an embodiment of the present invention, a method, system and computer program product can be provided for a unified form of an application installation engine. In the embodiment of the invention, an installation package can be treated as a source repository. Likewise, the target platform can be treated as a target repository. As such, a merge operation can be performed on meta-data for each of the source repository and target repository in order to produce any of an installation, an update or an uninstallation.

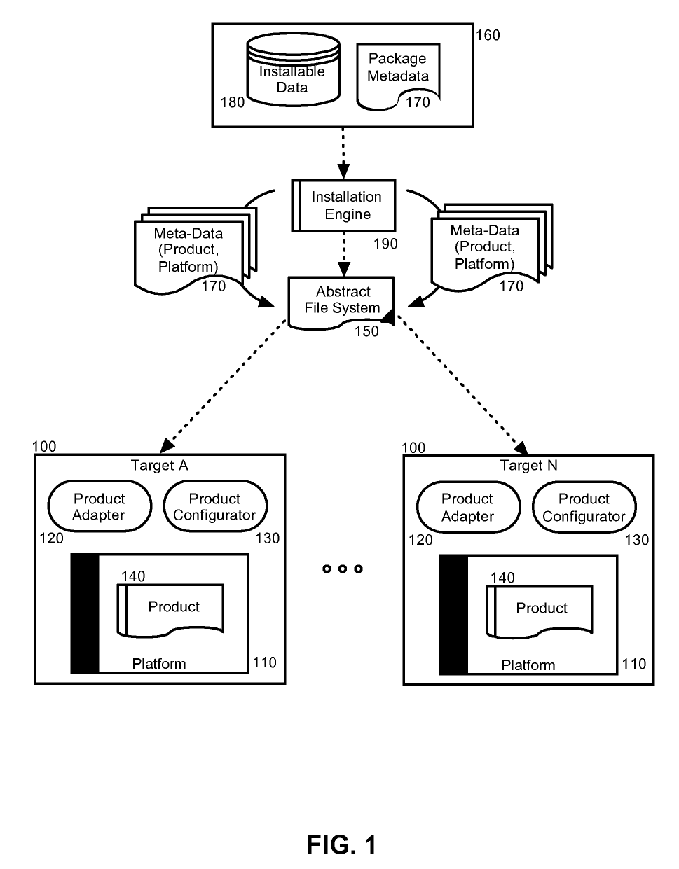

In illustration, FIG. 1 is a schematic illustration of a data processing system configured for application installation. As used herein, the term “data processing system” is intended to have a broad meaning, and may include personal computers, laptop computers, palmtop computers, handheld computers, network computers, servers, workstations, cellular telephones and similar wireless devices, personal digital assistants and other electronic devices on which software programs may be installed. The data processing system can include an installation engine 190 configured to install, uninstall, or update application products 140 in respective target platforms 110 in one or more target environments 100.

Notably, the abstract file system 150 can provide an application programming interface (API) for a minimal set of file system operations. The minimal set of file system operations can be enabled to produce concrete file operations in specific target platforms through logic provided by concrete adapters for the specific target platforms. In this regard, the abstract file system 150 can locate one or more specific operations for a specific target platform in a concrete adapter that corresponds to one or more invoked abstract file I/O requests. In this way, an unlimited set of target platforms, including target operating systems on local or remote hosts, target Web services hosts, and the like can be supported by the abstract file system 150 merely by plugging-in additional concrete adapters corresponding to additional specific target platforms.

In operation, the installable package 160 can include installable data 180 including program files, and package meta-data 170 describing the content of the installable data 180. The meta-data 170 can include installation instructions in the form of a sequence of operations to be performed in a target platform irrespective of the type of target platform. The meta-data 170 can be processed in the installation engine 190 to invoke abstract installation operations published in the API for the abstract file system 150. The abstract file system 150, in turn, can invoke a product adapter 120 specific to a particular target platform 110 in order to transform or convert the abstract installation operations into operations specific to the target platform 110. Additionally, a product configurator 130 can process abstract configuration operations from the abstract file system 150 in order to specifically configure the target platform 110.

In view of the foregoing arrangement, a universal updater technology can be provided to update any product irrespective of the install technology used to create, install, or configure the product, or the platform hosting the product installation. The universal updater or installer embodied within the installation engine 190 can allow for any number of products or operating systems to be supported so long as a corresponding product adapter has been defined and registered with the installation engine that conforms with the API of the abstract file system, and suitable meta-data 170 describing the product, product configuration, install and build architectures is provided. Once the adapter has been registered with the installation engine, the installation engine can transparently begin to update the corresponding product. Therefore, the update technology described herein can be completely platform independent, so that it can update products across vendors, operating systems, and platforms.

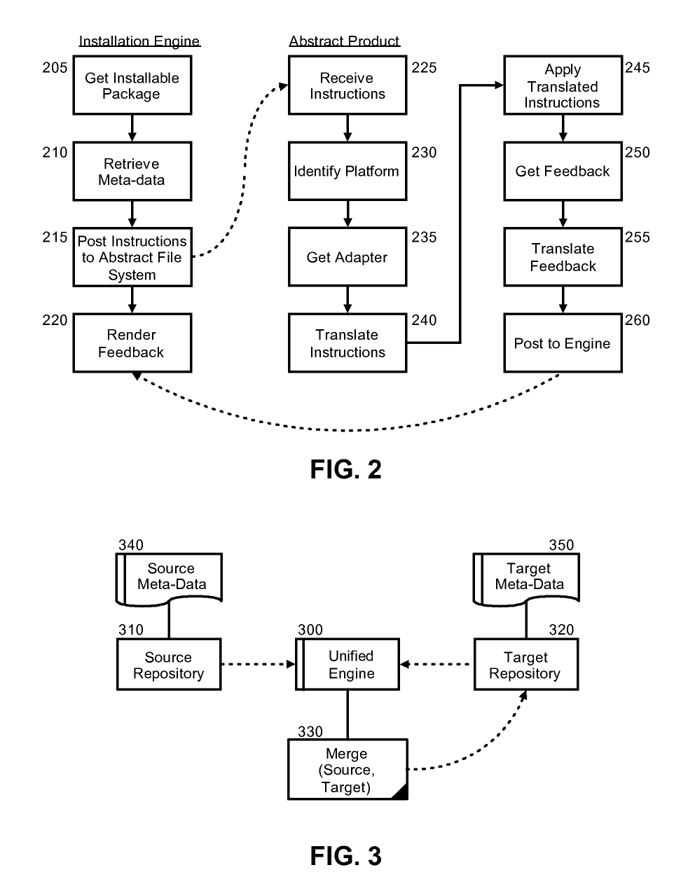

In further illustration, FIG. 2 is a flow chart illustrating a process for application installation. Beginning in block 205, an installable package can be selected for installation and in block 210, package meta-data can be retrieved for the installable package. The package meta-data can include encoded installation instructions conforming to the API for the abstract file system. In block 215, the instructions of the package meta-data can be posted to the abstract file system which instructions can be further processed in blocks 225 through 260.

In block 225, the instructions can be received in the abstract file system and in block 230, a target platform can be identified for the installation. Thereafter, in block 235 an adapter can be located and a reference can be obtained to the located adapter. The adapter can be invoked in block 240 to translate the received instructions into platform specific instructions. Notably, the received instructions can include not only data operations encoded in the package meta-data, but also configuration operations encoded in the package meta-data. In any event, in block 245, the translated instructions can be applied in the target platform.

In block 250, feedback can be received from the target platform which feedback can include platform-specific installation messages and the like. In block 255, the feedback can be translated into an abstracted form. Subsequently, in block 260, the abstracted form of the feedback can be posted to the installation engine. Finally, in block 220 the feedback can be rendered for viewing and the installation process will have been completed.

Importantly, the installation engine of FIG. 1 can be generalized in a uniform manner in order to uniformly handle installation, update and uninstallation operations as a unified engine without providing specific code paths for each individual operation. To achieve a unified engine, source installation packages are treated as source repositories and target products within target platforms are treated as target repositories. To effectuate any of an installation, update or uninstallation operation, then, only a merge data operation is required on the meta-data for the source and target repositories. In yet further illustration, FIG. 3 is a block diagram illustrating a unified form of the installation engine of FIG. 1.

As shown in FIG. 3, the installation engine can be a unified engine 300. The unified engine can receive the source meta-data 340 for a source repository 310, and the target meta-data 350 for the target repository 320. A merge data operation 330 can act upon the source meta-data 340 and the target meta-data 350 in order to produce a final target set of meta-data. The final target set of meta-data thereafter can be processed in the unified engine through the abstract file systems to effectuate any of an installation, update or uninstallation operation. Thus, the unified engine will merge files in the source repository with files in the target repository to form a final target comprising merged files, and will then place the merged files in the final target in the target repository through input/output method invocations on an abstract file system.

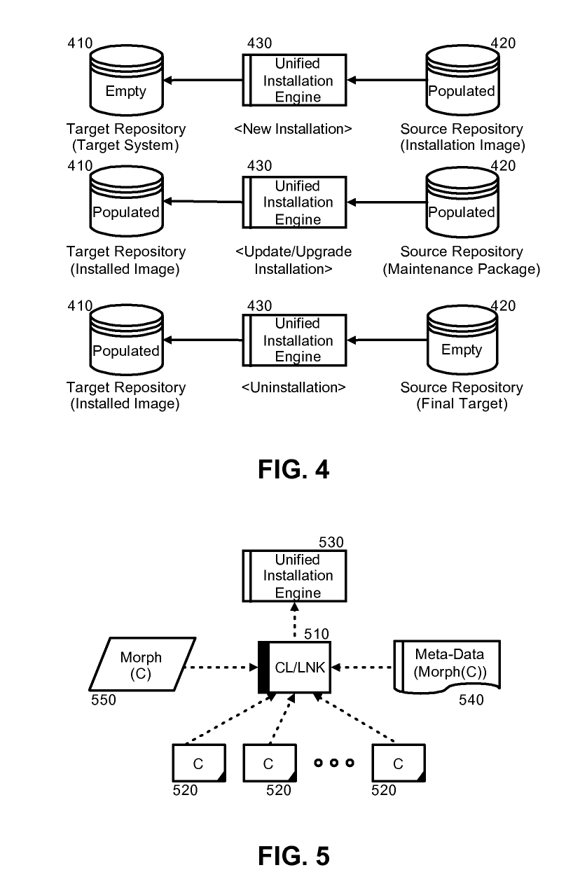

More particularly, referring to FIG. 4, in the event where the target repository 410 is empty and the source repository 420 is populated, the unified installation through a merge data operation will effectuate an installation of the installation image reflected in the source repository 420 onto the target repository. By comparison, where the target repository 410 is populated and the source repository 420 is populated, the unified installation through a merge data operation will effectuate an update of the already installed image reflected in the target repository 410. Finally, where the target repository 410 is populated and the source repository 420 is empty, the unified installation through a merge data operation will effectuate an uninstallation of the already installed image reflected in the target repository 410.

Finally, the unified installation engine 300 of FIG. 3 can be adapted to accommodate changes in its logic without requiring a re-write of the core logic. Rather, the unified installation engine can be externally polymorphically extended to achieve an updated form. In particular, as shown in FIG. 5, a class loader or linker 510 can be provided to load or link one or more different programmatic objects 520 into the unified installation engine 530. The class loader or linker 510, however, can be overridden to read the meta-data 540 for a morphed form 550 of one of the programmatic objects 520 and to load in its stead the morphed form 550 so long as the morphed form 550 has an interface that comports with the interface expected by the class loader or linker 510. In this way, the unified installation engine 530 can be extended merely by injecting different meta-data for one or more of the programmatic objects 520 that refers to different morphed forms of the programmatic objects 520.

Embodiments of the invention can take the form of an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. An application installation method comprising:
specifying an installation package for a software product as a source repository and specifying a target repository in a target platform hosted by at least one computing system; and,
executing a merge operation with each of the source repository and the target repository so that the target repository is updated according to the source repository.

2. The method of claim 1, wherein executing a merge operation with each of the source repository and the target repository, comprises executing a merge operation with each of the source repository and the target repository to perform a platform agnostic application installation irrespective of a specific type of platform for the target repository.

3. The method of claim 1, wherein executing a merge operation with each of the source repository and the target repository, comprises executing a merge operation with each of an empty target repository and a populated source repository to achieve an installation operation in the target repository.

4. The method of claim 1, wherein executing a merge operation with each of the source repository and the target repository, comprises executing a merge operation with each of a populated source repository and a populated target repository to achieve an application update operation in the target repository.

5. The method of claim 1, wherein executing a merge operation with each of the source repository and the target repository, comprises executing a merge operation with each of an empty source repository and a populated target repository to achieve an uninstallation operation in the target repository.

6. The method of claim 1, wherein executing a merge operation with each of the source repository and the target repository, comprises:
merging files in the source repository with files in the target repository to form a final target comprising merged files; and,
placing the merged files in the final target in the target repository through input/output method invocations on an abstract file system.

7. The method of claim 6, wherein placing the merged files in the final target in the target repository through input/output method invocations on an abstract file system, comprises:
retrieving meta-data for the merged files; and,
posting instructions in the meta-data to the abstract file system, the abstract file system adapting the instructions to platform-specific instructions specific to the target platform.

8. The method of claim 7, further comprising:
receiving platform-specific feedback to the platform specific instructions;
adapting the platform specific feedback to an abstracted form; and,
rendering the abstracted form of the platform-specific feedback.

9. An application installation data processing system comprising:
a unified installation engine; and,
a merge-data operation coupled to the engine and comprising program code enabled to execute a merge operation with each of a source repository and a target repository so that the target repository is updated according to the source repository.

10. The system of claim 9, wherein the unified installation engine is configured for coupling to an abstract file system.

11. The system of claim 10, wherein the abstract file system comprises a minimal set of abstract file input/output (I/O) operations translatable to concrete file I/O operations through an adapter specific to the platform hosting the target repository.

12. The system of claim 11, wherein the abstract file system further comprises abstract product configuration operations translatable to concrete product configurations via a product configurator associated with the platform hosting the target repository.

13. A computer program product comprising a computer usable medium having computer usable program code for application installation, the computer program product including:
computer usable program code for specifying an installation package for a software product as a source repository and for specifying a target repository in a target platform hosted by at least one computing system; and,
computer usable program code for executing a merge operation with each of the source repository and the target repository so that the target repository is updated according to the source repository.

14. The computer program product of claim 13, wherein the computer usable program code for executing a merge operation with each of the source repository and the target repository, comprises computer usable program code for executing a merge operation with each of the source repository and the target repository to perform a platform agnostic application installation irrespective of a specific type of platform for the target repository.

15. The computer program product of claim 13, wherein the computer usable program code for executing a merge operation with each of the source repository and the target repository, comprises computer usable program code for executing a merge operation with each of an empty target repository and a populated source repository to achieve an installation operation in the target repository.

16. The computer program product of claim 13, wherein the computer usable program code for executing a merge operation with each of the source repository and the target repository, comprises computer usable program code for executing a merge operation with each of a populated source repository and a populated target repository to achieve an application update operation in the target repository.

17. The computer program product of claim 13, wherein the computer usable program code for executing a merge operation with each of the source repository and the target repository, comprises computer usable program code for executing a merge operation with each of an empty source repository and a populated target repository to achieve an uninstallation operation in the target repository.

18. The computer program product of claim 13, wherein the computer usable program code for executing a merge operation with each of the source repository and the target repository, comprises:
computer usable program code for merging files in the source repository with files in the target repository to form a final target comprising merged files; and,
computer usable program code for placing the merged files in the final target in the target repository through input/output method invocations on an abstract file system.

19. The computer program product of claim 13, wherein the computer usable program code for placing the merged files in the final target in the target repository through input/output method invocations on an abstract file system, comprises:
computer usable program code for retrieving meta-data for the merged files; and,
computer usable program code for posting instructions in the meta-data to the abstract file system, the abstract file system adapting the instructions to platform-specific instructions specific to the target platform.

20. The computer program product of claim 19, further comprising:
computer usable program code for receiving platform-specific feedback to the platform specific instructions;
computer usable program code for adapting the platform-specific feedback to an abstracted form; and,
computer usable program code for rendering the abstracted form of the platform-specific feedback.
